(19) United States
(12) Patent Application Publication
(10) Pub. No.: US 2014/0071083 A1
(43) Pub. Date: Mar. 13, 2014

(54) DIGITIZER

(71) Applicant: SAMSUNG ELECTRO-MECHANICS CO., LTD., Suwon (KR)

(72) Inventors: Dong Sik Yoo, Suwon (KR); Hee Bum Lee, Suwon (KR); Kyoung Soo Chae, Suwon (KR); Ho Yun Cho, Suwon (KR); Seung Joo Shin, Suwon (KR); Yun Ki Hong, Suwon (KR)

(73) Assignee: SAMSUNG ELECTRO-MECHANICS CO., LTD., Suwon (KR)

(21) Appl. No.: 13/730,205

(22) Filed: Dec. 28, 2012

(30) Foreign Application Priority Data
Sep. 10, 2012 (KR) 10-2012-0100092

(51) Int. Cl. G06F 3/044

(52) U.S. Cl. CPC G06F 3/044
USPC 345/174

(57) ABSTRACT

Disclosed herein is a digitizer including: a transparent substrate; an electrode formed on the transparent substrate to sense a change in capacitance; and a coil formed on the transparent substrate to receive a signal transmitted from the outside. As the touch input unit, various units such as an electronic pen and user's finger, and the like, can be used.

### CROSS REFERENCE TO RELATED APPLICATION

This application claims the benefit of Korean Patent Application No. 10-2012-0100092, filed on Sep. 10, 2012, entitled “Digitizer”, which is hereby incorporated by reference in its entirety into this application.

### BACKGROUND OF THE INVENTION

1. Technical Field

The present invention relates to a digitizer.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

While the rapid advancement of an information-oriented society has widened the use of computers more and more, it is difficult to efficiently operate products using only a keyboard and a mouse currently serving as an input device. Therefore, the necessity for a device that is simple, has minimum malfunction, and is capable of easily inputting information has increased.

In addition, current techniques for input devices have progressed toward techniques related to high reliability, durability, innovation, designing and processing beyond the level of satisfying general functions. To this end, an electromagnetic induction type digitizer has been developed as an input device capable of inputting information such as text, graphics, or the like.

An example of the digitizer according to the prior art may include a digitizer disclosed as the background art in Korean Patent No. 10-0510729.

The digitizer disclosed in the Korean Patent No. 10-0510729 is configured to include a sensor unit disposed under a liquid crystal panel and transmitting and receiving electromagnetic waves resonated at a location at which an electronic pen is touched to recognize the touched location and a control unit controlling the sensor unit. Here, the sensor unit is configured to include a sensor PCB and a plurality of X-axis coils and Y-axis coils formed on the sensor PCB. Further, the control unit is disposed under the sensor unit and serves to transmit a signal to the sensor unit and read a signal input again to sense a location of an electronic pen. Moreover, the electronic pen includes a resonance circuit configured of a coil and a capacitor formed therein.

The digitizer according to the prior art is operated by transmitting a signal from the control unit to the sensor unit and generates electromagnetic waves while inducing electromagnetism by selecting the X-axis and Y-axis coils. The electronic pen is resonated by the generated electromagnetic waves and a resonance frequency is received by the sensor unit while being held for a predetermined time. The control unit reads the signal received by the sensor to sense the touched location.

However, the digitizer according to the prior art needs to include the electronic pen having a resonance circuit embedded therein so as to detect the touched location. Therefore, there is a problem in that an input unit used to detect the touched location is limited.

### SUMMARY OF THE INVENTION

The present invention has been made in an effort to provide a digitizer having a capacitive type touch panel structure integrated therewith so as to detect a touched location to use various input units such as a user's hand, electronic pen, and the like.

Further, the present invention has been made in an effort to provide a digitizer capable of detecting an approach and a writing pressure of an electronic pen while detecting a touched location when an electronic pen is used.

According to a preferred embodiment of the present invention, there is provided a digitizer including: a transparent substrate; an electrode formed on the transparent substrate to sense a change in capacitance; and a coil formed on the transparent substrate to receive a signal transmitted from the outside.

The coil may receive a magnetic field signal transmitted from an electronic pen to sense an approach of the electronic pen.

The coil may receive a writing pressure signal transmitted from the electronic pen.

The coil may transmit a power signal to the electronic pen.

The transparent substrate may be partitioned into an active area and an inactive area at the outside of the active area, the electrode may be formed in the active region on one surface of the transparent substrate, and the coil may be formed in the inactive region on one surface of the transparent substrate.

The coil may be extendedly formed up to the inactive region on the other surface of the transparent substrate through a via hole formed on the transparent substrate.

The transparent substrate may be partitioned into an active area and an inactive area at the outside of the active area, the electrode may be formed in the active region on one surface of the transparent substrate, and the coil may be formed in the inactive region on the other surface of the transparent substrate.

The electrode may be formed in a mesh pattern.

The electrode may be formed of any one selected from copper (Cu), aluminum (Al), gold (Au), silver (Ag), titanium (Ti), palladium (Pd), and chromium (Cr), or a combination thereof.

The electrode may be formed of metal silver formed by exposing/developing a silver salt emulsion layer.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a plan view showing a transparent substrate of a digitizer according to a first preferred embodiment of the present invention;

FIG. 2 is a plan view of the digitizer according to the first preferred embodiment of the present invention;

FIG. 3 is a cross-sectional view taken along the line A-A′ shown in FIG. 1;

FIG. 4 is a cross-sectional view taken along the line B-B′ shown in FIG. 1;

FIG. 5 is a cross-sectional view showing a state in which a window glass is bonded to the digitizer shown in FIG. 1; and

FIG. 6 is a cross-sectional view of the digitizer according to a second preferred embodiment of the present invention.

### DESCRIPTION OF THE PREFERRED EMBODIMENTS

The above and other objects, features and advantages of the present invention will be more clearly understood from preferred embodiments and the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted. In the description, the terms “first”, “second”, and so on are used to distinguish one element from another element, and the elements are not defined by the above terms.

Hereinafter, preferred embodiments of the present invention will be described in detail with reference to the accompanying drawings.

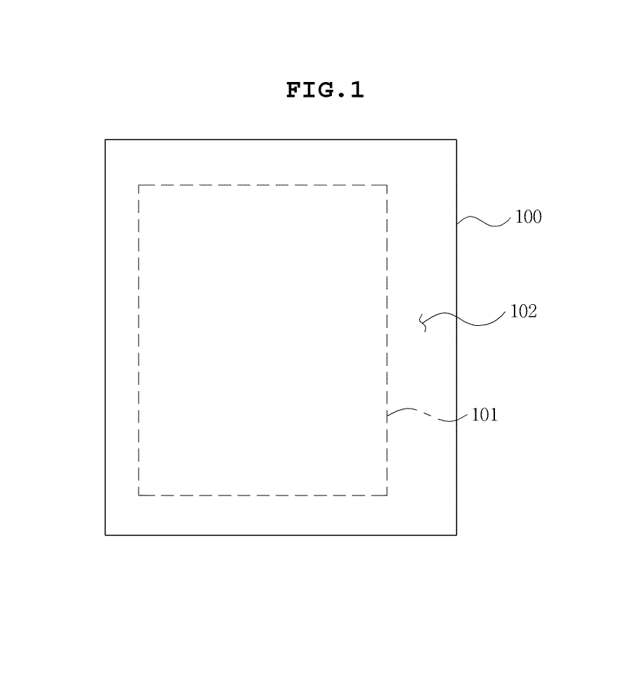

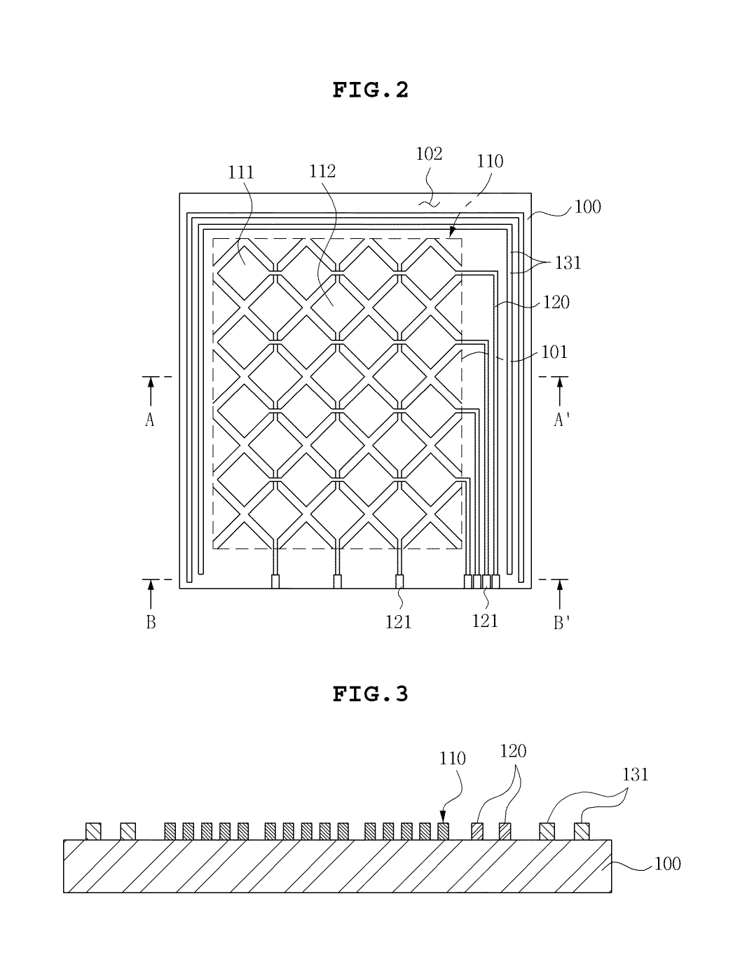

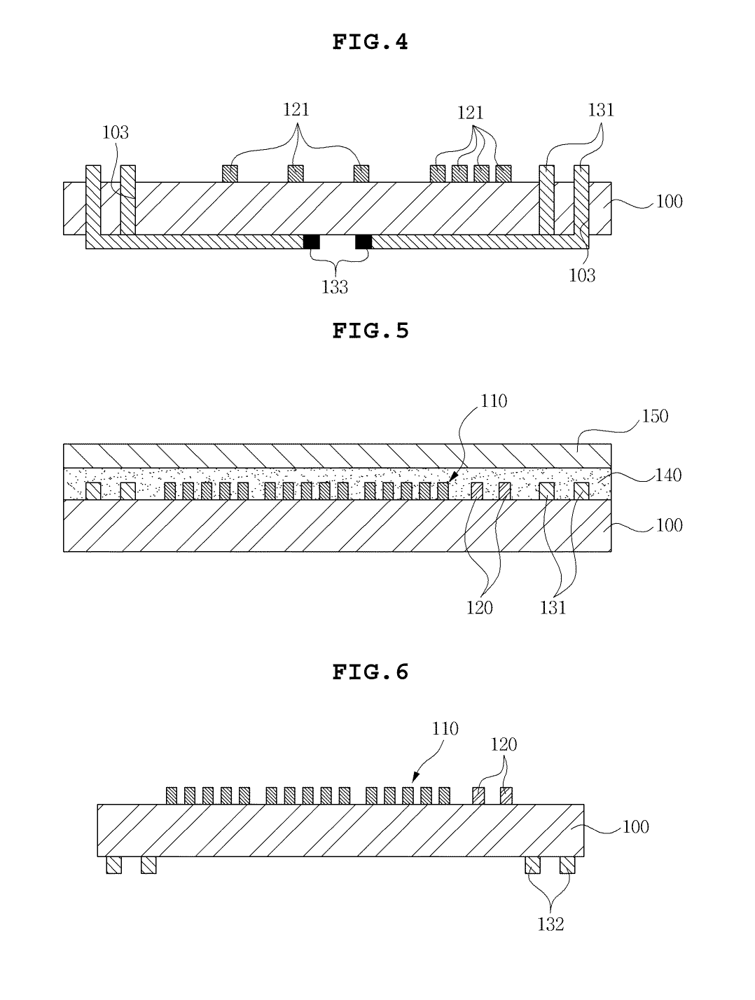

FIG. 1 is a plan view showing a transparent substrate of a digitizer according to a first preferred embodiment of the present invention and FIG. 2 is a plan view of the digitizer according to the first preferred embodiment of the present invention. FIG. 3 is a cross-sectional view taken along the line A-A′ shown in FIG. 1 and FIG. 4 is a cross-sectional view taken along the line B-B′ shown in FIG. 1. FIG. 5 is a cross-sectional view showing a state in which a window glass is bonded to the digitizer shown in FIG. 1.

As shown in FIGS. 1 to 4, the digitizer according to the first preferred embodiment of the present invention includes a transparent substrate 100, an electrode 110 formed on the transparent substrate 100 to sense a change in capacitance, and a coil 131 formed on the transparent substrate 100 to receive a signal received from the outside.

The digitizer 1 according to the preferred embodiment of the present invention is a digitizer in which a capacitive type touch panel structure is integrated. Therefore, the transparent substrate 100 and the electrode 110 included in the preferred embodiment of the present invention serves to perform the same function as a transparent substrate and an electrode included in the capacitive type touch panel structure.

In detail, the transparent substrate 100 provides an area in which the electrode 110 and the coil 131 to be described below are formed. The transparent substrate 100 needs to have support force capable of supporting the electrode 110 and the coil 131 and transparency to allow a user to recognize images provided from an image display device.

In consideration of the support force and the transparency described above, the transparent substrates 110 and 130 may be made of polyethylene terephthalate (PET), polycarbonate (PC), poly methyl methacrylate (PMMA), polyethylene naphthalate (PEN), polyethersulpon (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, or tempered glass, but are not necessarily limited thereto.

The one surface of the transparent substrate 100 is preferably activated by being subjected to high frequency treatment or primer treatment. The transparent substrate 100 is treated as described above, thereby more improving adhesion between the transparent substrate 100 and the electrode 110 and between the transparent substrate 100 and the coil 131.

As shown in FIG. 1, the transparent substrate 100 may be partitioned into the active area 101 and the inactive area 102. The active area 101 is an area in which the electrode 110 is formed and may be referred to as an area in which the touched signal is generated. In addition, the inactive area 102 is partitioned from the active area 101 while occupying the outside of he active area 101. The inactive area 102 is an area that is covered by black or white bezel part (not shown) so as not to be visualized from the outside and may be formed with a wiring 120 that is connected to the electrode 110 to be described below. Further, the coil 131 to be described below may also be formed. The wiring 120 or the coil 131 is formed in the inactive area 120 and thus, is covered by the bezel part so as not to be visualized from the outside.

When the user touches the electrode 110 using, for example, his/her finger or the electronic pen having a conductive tip formed therein, the electrode 110 recognizes the change in capacitance to generate a signal, which is in turn transmitted to a controller (not shown), wherein the signal serves to allow the controller to recognize touched coordinates.

The electrode 110 may include, for example, a first electrode 111 and a second electrode 112.

The first electrode 111 may be formed on the active area 101 on one surface of the transparent substrate 100. Further, the first electrode 111 may be formed of metals consisting of any one selected from copper (Cu), aluminum (Al), gold (Au), silver (Ag), titanium (Ti), palladium (Pd), and chromium (Cr), or a combination thereof and may be formed on one surface of the transparent substrate 100 in mesh patterns by methods such as a plating process, an evaporation process, and the like. In this case, as shown in FIG. 2, the first electrode 111 may be formed on the transparent substrate 100 in diamond patterns arranged in a first direction and bridge patterns connecting between the diamond patterns.

The second electrode 112 may be formed together with the first electrode 111 in the active area 101 on one surface of the transparent substrate 100. The second electrode pattern 112 may also be formed of metals consisting of any one selected from copper (Cu), aluminum (Al), gold (Au), silver (Ag), titanium (Ti), palladium (Pd), and chromium (Cr), or a combination thereof and may be formed in the mesh patterns. The second electrode 112 may be formed on the transparent substrate 100 in diamond patterns arranged in a second direction and bridge patterns connecting between the diamond patterns. In this case, the diamond patterns configuring the second electrode 112 may be formed so as to fill the transparent substrate 100 area that does not overlap the diamond patterns configuring the first electrode 111.

Any one of the first electrode 111 and the second electrode 112 may be used as a sensing electrode and the other thereof may be used as a driving electrode.

Meanwhile, the electrode 110 is formed in the mesh patterns and is not necessarily formed in the diamond patterns as described above. The diamond 110 may be formed in various types of known patterns in addition to the diamond form.

In addition, the electrode 110 is not limited as being formed by the foregoing materials and processes. The electrode 110 may be formed of metal silver formed by exposing/developing a silver salt emulsion layer in addition to the foregoing metals or may also be formed of metal oxide or conductive polymer.

As shown in FIGS. 2 and 3, the coil 131 is formed on the inactive area 102 on one surface of the transparent substrate 100 to serve to receive the signal transmitted from the outside. The signal received by the coil 131 may be transmitted from a touch location input unit which may be, for example, an electronic pen.

The electronic pens have a known configuration that is generally used as the touch input unit of the digitizer and may include a resonance circuit having an inductor and a capacitor disposed therein. The resonance circuit of the electronic pen is resonated by electromagnetic force input from the outside. The resonance circuit generates induced current while being resonated and energy generated by the generated induced current may be stored in the capacitor. Further, when the supply of electromagnetic force stops from the outside, in the electronic pen, the capacitor is resonated with the inductor by the energy stored in the capacitor. During the resonance, the electromagnetic force is discharged.

When the electronic pen approaches the digitizer, the coil 131 may receive the magnetic field signal from the electronic pen to sense the approach of the electronic pen. The signal received from the coil 131 is transmitted to the control unit and the control unit may perform a control to perform required functions according to the approach of the electronic pen.

The electronic pen may include a writing pressure sensor disposed therein. The electronic pen including the writing pressure sensor is already known and therefore, the detailed description thereof will be omitted herein. The electronic pen transmits the writing pressure signal sensed by the writing pressure sensor included therein and the coil 131 may receive the writing pressure signal so as to be transmitted to the control unit.

Meanwhile, the electronic pen including the resonance circuit disposed therein may be a powerless input device that is resonated by receiving electromagnetic force from the outside and the coil 131 may serve as a power coil supplying electromagnetic force, that is, transmitting the power signal to the electronic pen. The control unit may be controlled so as to apply driving power to the coil 131 and when the coil 131 discharges the electromagnetic force by the applied power, the resonance circuit of the electronic pen stores the input electromagnetic force. The electromagnetic pen may use the stored energy so as to use the driving power of components embedded in the electronic pen.

Meanwhile, the foregoing electrode 110 is electrically connected with the wiring 120 that is formed in the inactive area 102. In addition, a distal end of the wiring 120 is a connection terminal 121 that is connected to a flexible printed circuit board (FPCB). In addition, a distal end of the foregoing coil 131 is also a connection terminal 133 that is connected to the flexible circuit board.

Both of the connection terminal 121 of the wiring 120 and the connection terminal 133 of the coil 131 may be disposed in the inactive area 102 on one surface of the transparent substrate 100. However, the inactive area 102 of the transparent substrate 100 may preferably have a narrow area as maximally as possible. Therefore, only the connection terminal 121 of the wiring 120 is disposed on the inactive area 102 on one surface of the transparent substrate 100 and the connection terminal 133 of the coil 131 is disposed on the inactive area 102 on the other surface of the transparent substrate 100, thereby effectively using the space.

To this end, as shown in FIG. 4, the transparent substrate 100 may be provided with a via hole 103 and the coil 131 may be extendedly formed up to the inactive area 102 on the other surface of the transparent substrate 100 via the via hole 103. The coil is formed as described above and thus, a cross portion between the coil 131 and the wiring 120 may be minimized or removed.

Meanwhile, as shown in FIG. 5, the preferred embodiment of the present invention may further include the window glass 150. The window glass 150 may be a member to which the touch operation by the user is directly applied and may be bonded by the adhesive layer 140 so as to be integrated with the transparent substrate 100. In this case, the adhesive layer may be an optical clear adhesive (OCA).

Hereinafter, a digitizer according to a second preferred embodiment of the present invention will be described with reference to the accompanying drawings. FIG. 6 is a cross-sectional view of the digitizer according to a second preferred embodiment of the present invention.

The second preferred embodiment of the present invention is slightly different from the first preferred embodiment of the present invention. However, the difference between the second preferred embodiment of the present invention and the first preferred embodiment of the present invention is that the location of the coil formed on the transparent substrate 100 is different. Therefore, only the difference will be described below in detail.

As shown in FIG. 6, the coil 132 according to the second embodiment of the present invention is formed in the inactive area 102 on the other surface of the transparent substrate 100. When the electrode 110 is formed on one surface of the transparent substrate 100 and the wiring 120 connected with the electrode 110 is formed in the inactive area 102 on one surface of the transparent substrate 100, in the second preferred embodiment of the present invention, the coil 132 is formed in the inactive area 102 on the other surface of the transparent substrate 102 so as not to overlap the wiring 120. Therefore, there is no need to unnecessarily expand the inactive area 102. In addition, the transparent substrate 100 needs not to form the separate via hole 103 (see FIG. 4).

According to the preferred embodiments of the present invention, it is possible to use various units, such as the electronic pen, the user's finger, and the like, as the input unit by forming the coil for receiving the signal transmitted from the electronic pen and the electrode for sensing the change in capacitance on the transparent substrate.

Further, it is possible to detect the touched location of the input unit and check the approach and writing pressure of the electronic pen at the time of using the electronic pen.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A digitizer, comprising:
a transparent substrate;
an electrode formed on the transparent substrate to sense a change in capacitance; and
a coil formed on the transparent substrate to receive a signal transmitted from the outside.

2. The digitizer as set forth in claim 1, wherein the coil receives a magnetic field signal transmitted from an electronic pen to sense an approach of the electronic pen.

3. The digitizer as set forth in claim 1, wherein the coil receives a writing pressure signal transmitted from the electronic pen.

4. The digitizer as set forth in claim 1, wherein the coil transmits a power signal to the electronic pen.

5. The digitizer as set forth in claim 1, wherein the transparent substrate is partitioned into an active area and an inactive area at the outside of the active area,
the electrode is formed in the active region on one surface of the transparent substrate, and
the coil is formed in the inactive region on one surface of the transparent substrate.

6. The digitizer as set forth in claim 2, wherein the coil is extendedly formed up to the inactive region on the other surface of the transparent substrate through a via hole formed on the transparent substrate.

7. The digitizer as set forth in claim 1, wherein the transparent substrate is partitioned into an active area and an inactive area at the outside of the active area,
the electrode is formed in the active region on one surface of the transparent substrate, and
the coil is formed in the inactive region on the other surface of the transparent substrate.

8. The digitizer as set forth in claim 1, wherein the electrode is formed in a mesh pattern.

9. The digitizer as set forth in claim 1, wherein the electrode is formed of any one selected from copper (Cu), aluminum (Al), gold (Au), silver (Ag), titanium (Ti), palladium (Pd), and chromium (Cr), or a combination thereof.

10. The digitizer as set forth in claim 1, wherein the electrode is formed of metal silver formed by exposing/developing a silver salt emulsion layer.
